(19) United States
(12) Patent Application Publication
(10) Pub. No.: US 2004/0122717 A1
(43) Pub. Date: Jun. 24, 2004

(54) Claim submission system and method

(76) Inventor: James Hancock, Coldwater (CA)

Correspondence Address: ORANGE & CHARI, 66 Wellington St. W., Suite 4900, P.O. Box 190, Toronto, ON, M5K 1H6, CA

(21) Appl. No.: 10/326,972

(22) Filed: Dec. 24, 2002

(30) Foreign Application Priority Data
Dec. 23, 2002 (CA) 2,409,078

(51) Int. Cl. G06F 17/60; G06F 7/00; G06F 17/00

(52) U.S. Cl. 705/4; 707/104.1; 705/2

(57) ABSTRACT

A system and method to provide requested insurance data for populating data fields of an electronic claim form. The system comprises: a database including insurance related patient data and provider data; an interface for accessing the database, the interface capable of displaying the electronic claim form on a display; a unique identifier data field associated with the claim form, the unique identifier field for directing retrieval of the patient data and the provider data from the database, a set of unique identifiers employable by the unique identifier data field for associating an office location of each specified one of the providers with a respective one of the patients; and a data retrieval protocol for displaying the insurance data according to a selected one of the unique identifiers entered in the identifier data field; wherein the same unique identifier is associated with both the provider and the patient of the provider. The database also includes a patient database, a patient sub-database, a provider database, and a provider sub-database.

### BACKGROUND OF THE INVENTION

1. Field of the Invention

The present invention relates to the submission and processing of insurance claims, and more particularly to the completion of claim forms.

2. Description of the Prior Art

Currently, the insurance industry uses many different formats for insurance claim submission, including paper and electronic. Further, the insurers often receive claim submissions from a variety of sources, including patients, primary providers, secondary providers, and call centres. This distributed system of claim submission can result in many mistakes in the claim submission forms, which are detailed in nature. One solution that is used by insurers is to direct all claim submissions through experienced staff at the call centres.

However, the collection and electronic submission of claim data by the call centre staff can be laborious, including selecting relevant claim data from extensive databases. For example, patient and provider information are typically contained in detailed databases, and retrieval of this information displayed on database interfaces can be time consuming. Furthermore, as the insurance industry progresses to on-line real-time claim submission and adjudication, the efficient capture of the claim data into the appropriate electronic claim forms, both timely and correctly, is becoming evermore critical.

For example, it is common that multiple providers with many different offices treat patients. Further, it is also common that each health care professional may be employed by a number of different providers and practice at a number of office locations. This interconnectivity of patient and healthcare professional information can increase the response time of the call centre personnel in sorting out the relevant claim information from the detailed databases.

It is an object of the present invention to provide a claim submission system and method to obviate or mitigate at least some of the above-presented disadvantages.

### SUMMARY OF THE INVENTION

According to the present invention there is provided a method to request insurance data for populating data fields of an electronic claim form. The method comprises the steps of: supplying a database including insurance related patient data and provider data, associating a unique identifier data field with the claim form, the unique identifier field for directing retrieval of the patient data and the provider data from the database, the unique identifier data field using a set of unique identifiers for relating an office location of each specified one of the providers with a respective one of the patients; entering a selected one of the unique identifiers in the identifier data field; retrieving the insurance data from the database according to the selected one of the unique identifiers; and displaying the retrieved data in the electronic claim form; wherein the same unique identifier is associated with both the provider and the patient of the provider.

According to a further aspect of the present invention there is provided a system to provide requested insurance data for populating data fields of an electronic claim form. The system comprises: a database including insurance related patient data and provider data; an interface for accessing the database, the interface capable of displaying the electronic claim form on a display; a unique identifier data field associated with the claim form, the unique identifier field for directing retrieval of the patient data and the provider data from the database, a set of unique identifiers employable by the unique identifier data field for associating an office location of each specified one of the providers with a respective one of the patients; and a data retrieval protocol for displaying the insurance data according to a selected one of the unique identifiers entered in the identifier data field; wherein the same unique identifier is associated with both the provider and the patient of the provider.

According to a still further aspect of the present invention there is provided a computer program product to provide requested insurance data for populating data fields of an electronic claim form. The computer program product comprises: a computer readable medium; a database module stored on the computer readable medium for including insurance related patient data and provider data; an interface module coupled to the database module, the interface module capable of displaying the electronic claim form on a display; a unique identifier module associated with the claim form, the unique identifier module for directing retrieval of the patient data and the provider data from the database module, a set of unique identifiers employable by the identifier module for associating an office location of each specified one of the providers with a respective one of the patients; and a data retrieval module for displaying the insurance data according to a selected one of the unique identifiers used by the identifier module; wherein the same unique identifier is associated with both the provider and the patient of the provider.

### BRIEF DESCRIPTION OF THE DRAWINGS

These and other features of the preferred embodiments of the invention will become more apparent in the following detailed description in which reference is made to the appended drawings by way of example only, wherein:

FIG. 1 is a diagram of a claim submission system;

FIG. 2 shows the content of a patient/provider database of FIG. 1;

FIG. 3 shows the contents of a dataset of the database of FIG. 2,

FIG. 4 shows the contents of another dataset of the database of FIG. 2;

FIG. 5 shows the contents of another dataset of the database of FIG. 2;

FIG. 6 shows the contents of another dataset of the database of FIG. 2;

FIG. 7 gives a method for operating the system of FIG. 1;

FIG. 8 is an embodiment of the interface of the system of FIG. 1;

FIG. 9 is a further embodiment of the interface of the system of FIG. 1;

FIG. 10 is a further embodiment of the interface of the system of FIG. 1;

FIG. 11 is a further embodiment of the interface of the system of FIG. 1; and

FIG. 12 is a further embodiment of the interface of the system of FIG. 1.

### DESCRIPTION OF THE PREFERRED EMBODIMENTS

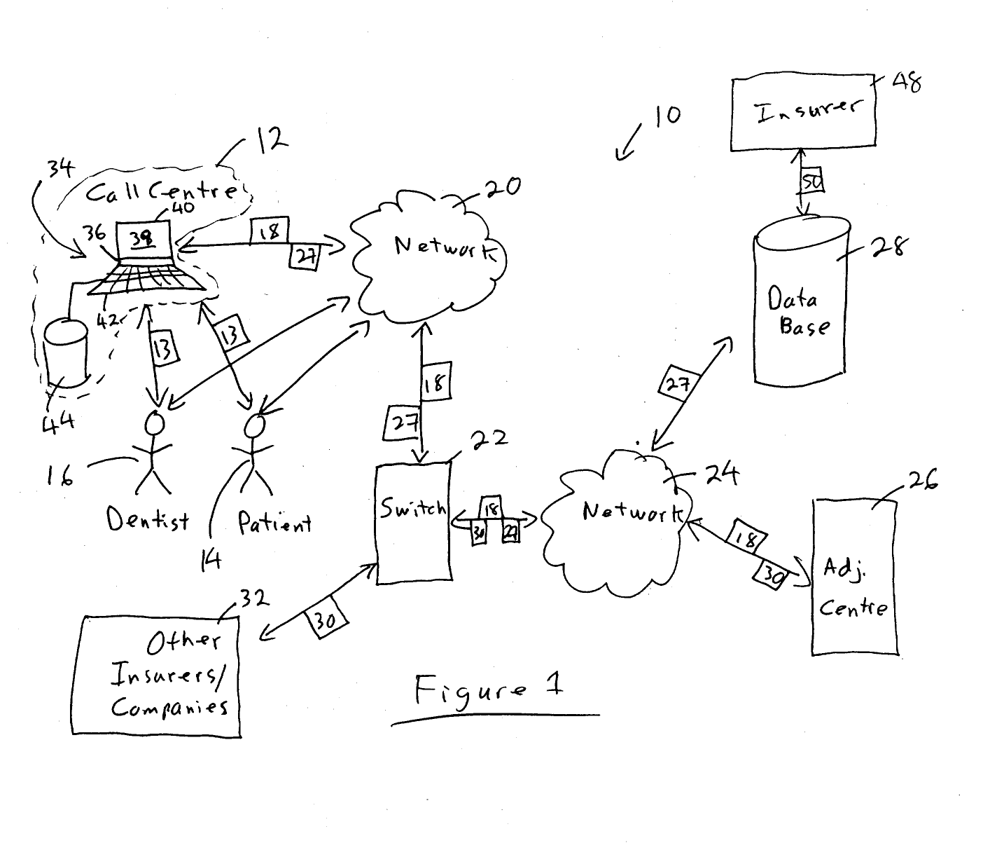

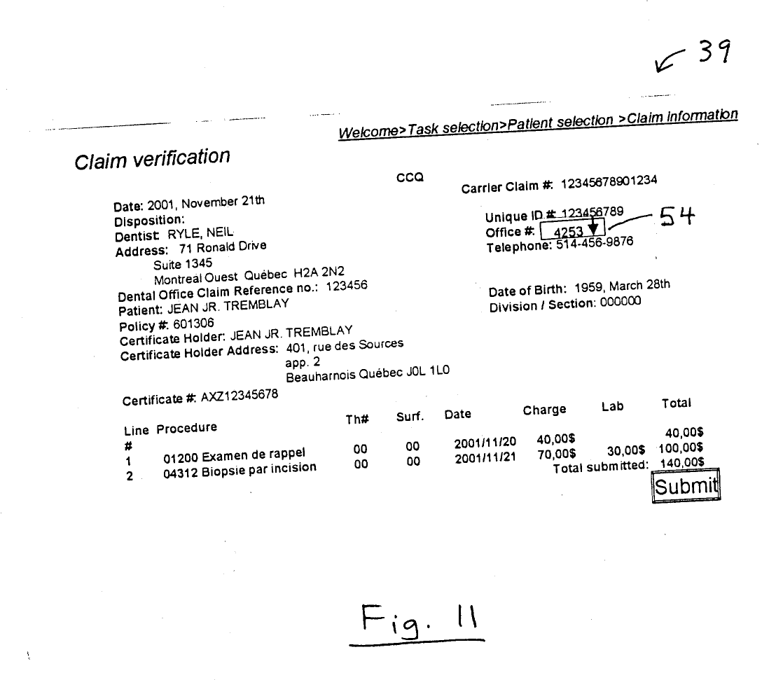

Referring to FIG. 1, a claim submission system 10 has a call centre 12 for receiving insurance information 13 relating to insurance claims from patients 14 and providers 16, such as but not limited to dentists. Once completed, the call centre 12 communicates insurance claims 18 over a network 20 to a communication switch 22, which directs the claims 18 (for example see FIG. 11 for an example electronic claim form format) over a secure network 24 to an adjudication centre 26. The submission format can be an EDI format as in known in the art. The adjudication centre 26 can perform real time adjudication of the claim 18 and report the adjudication results back to the patient 14 and/or provider 16 either though the call centre 12 or directly through the network 20. Patient and provider information 27 can be supplied to the call centre 12, upon request, from the patient/provider database 28. It is recognised that this information 27 can be used to supplement and/or otherwise pre-populate the claim information required by the call centre 12 to complete the claim 18, such that the information actively supplied by the provider 16 and/or patient 14 is minimised to help streamline the completion and processing of the claim 18. For example, preferably the claim 18 can be compiled by the call centre 12, and adjudicated by the adjudication centre 26 in fewer than 2 minutes. It is noted that the switch 22 can also direct claim information 30 from other sources 32 to the adjudication centre 26. Further, the switch 22 could also employ a translation module (not shown) to reformat the claims 18, 30 to a format required by the adjudication centre 26.

Referring again to FIG. 1, the call centre 12 can use a support system 34 for retrieving the claim information 18, 27 and monitoring processing of the claim 18 by the adjudication centre 26. The support system 34 can include a processor 36 coupled to an interface 39. The processor 36 is coupled to a display 40 for displaying the interface 39 and to user input devices 42, such as a keyboard, mouse, or other suitable devices. If the display 40 is touch sensitive, then the display 40 itself can be employed as the user input device 42. A computer readable storage medium 44 is coupled to the processor 36 for providing instructions to the processor 36 to instruct and/or configure the various components of the system 34, such as but not limited to presentation of the interface 39, and the processes related to operation of interface 39. These instructions can be used to help set-up and define the protocols and other procedures related to the operation of the system 34. The computer readable medium 44 can include hardware and/or software modules such as, by way of example only, magnetic disks, magnetic tape, optically readable medium such as CD ROM's, and semi-conductor memory such as PCMCIA cards. In each case, the medium 44 may take the form of a portable item such as a small disk, floppy diskette, cassette, or it may take the form of a relatively large or immobile item such as hard disk drive, solid state memory card, or RAM provided in the support system 34. It should be noted that the above listed example mediums 44 can be used either alone or in combination. Further, it is recognised that the medium 44 can have instructions/data for accessing the patient 14/provider 16 database 28 as required. The interface 39 is preferably a web interface for displaying the electronic claim forms.

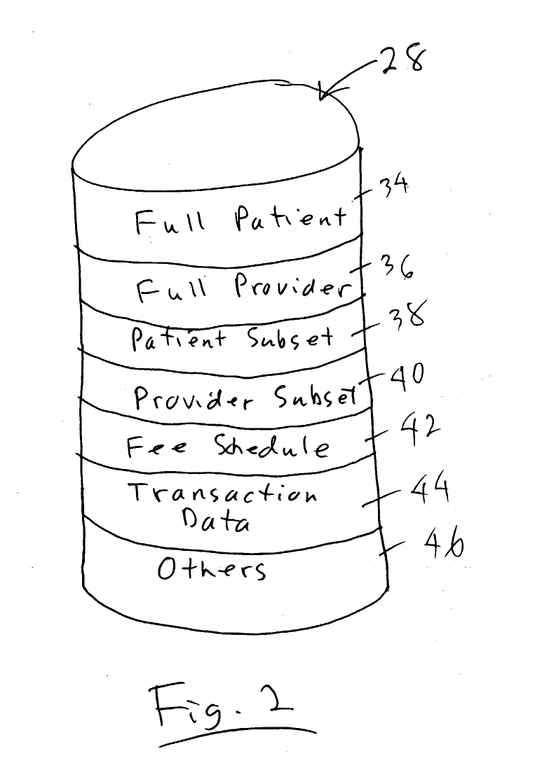

Referring to FIG. 2, the database 28 contains data sets relating to full patient 34, full provider 36, patient subset 38, provider subset 40, fee schedules and codes 42 (could also include service codes), transaction data 44 (for example history as well as status), and others 46. Accordingly, the database 28 is structured to help facilitate minimising transaction times for the claims 18, from data capture to processing to adjudication result. The database 28 is used to provide supplementary claim 18 data to the call centre 12 (see FIG. 1) to help reduce the keying in process of claim 18 data by the call centre 12 staff, the claim 18 data pertaining to patient 14 and provider 16 details somewhat independent from the particular insured services provided to the provider 16 to the patient 14, for example such as but not limited to during patient 14 visits to the provider 16 offices. Accordingly, the data sets 34, 36, 38, 40, 42, 44, and 46 are stored in look-up tables provided and maintained by insurers 48 (see FIG. 1) and providers 16 of the insured services.

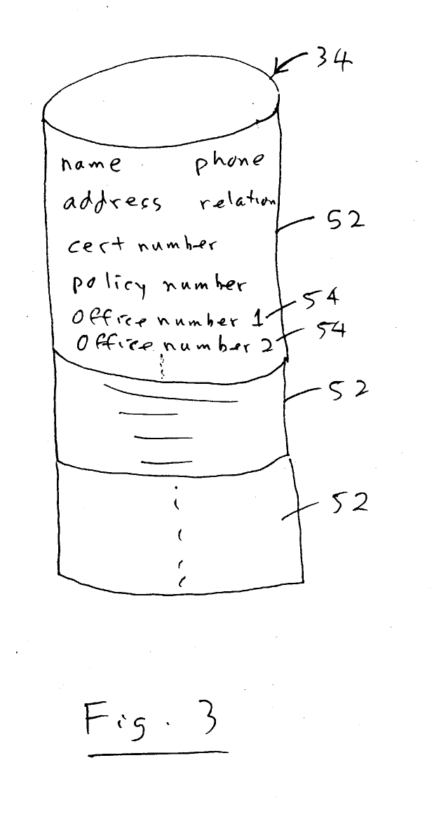

For example, referring to FIG. 3, data set 34 contains all the patient 14 information for each individual patient 52, such as but not limited to name, address, phone, relationship, certificate number of all the insured members enrolled with the insurer 48. This data set 34 is preferably updated on a daily basis (for example) from an upload file 50 sent by the insurer 48, containing Adds/Deletes/Modifications to the patient data contained within. Furthermore, the data set 34 also lists a provider office number 54 associated with each individual patient 52 data, or multiple provider office numbers 54 if the patient 52 has insured services provided by a number of provider offices 54. It should be noted that each provider office has a unique provider office number 54 or identifier assigned. Further, each patient 52 can have multiple provider office numbers 54 assigned to each patient 52 in the dataset 34, so as to help reduce having multiple records as per patient/provider office transactions.

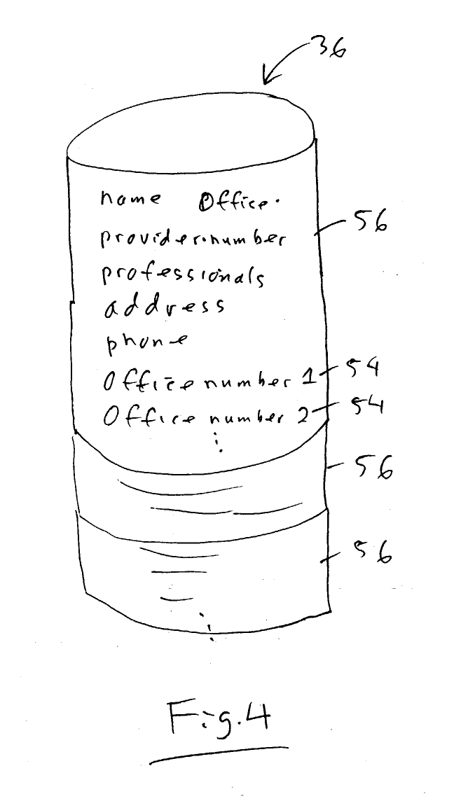

Referring to FIG. 4, dataset 36 contains all provider 16 (such as but not limited to dentist) information for each individual provider 56, such as but not limited to name, provider number, address, phone number, employed health care professionals, and provider office number 54. It should be noted that each individual provider 56 in the data set 36 may have multiple office locations, each with a unique provider office number 54. Similarly, the dataset 36 can be updated on a daily basis from the upload file 50 sent by the insurer 48, containing Adds/Deletes/Modifications. It should be noted that each provider 16 can have multiple provider office numbers 54 assigned to each individual provider 56 in the dataset 36, so as to help reduce having multiple records as per provider/office transactions.

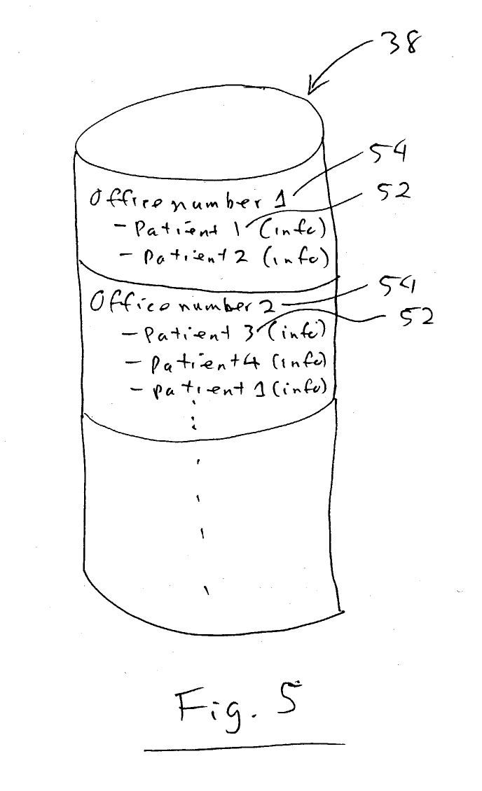

Referring to FIG. 5, the dataset 38 contains information similar information as the full patient dataset 34, however the individual patients 52 are assigned with their provider office number(s) 54 attached. It should be noted that the information contained in the dataset 38 is only that required to complete the claim 18. Extraneous patient 52 information, such as but not limited to history and validation information, may not required in the dataset 38. Accordingly, each patient 52 in the dataset 38 may have more than 1 entry with different office numbers 54 attached. One advantage to the different patient datasets 34, 38 is that in the dataset 34 there could be multiple patients 52 with the same last name, as compared to the potentially limited number of patients 52 with that name sorted as per provider office number 54. Therefore, the access and retrieval of the patient claim information from the database 28 by the call centre 12 staff is facilitated, when the call centre 12 instead of the dataset 34 accesses the dataset 38. The dataset 38 is also updated on a preset interval, which may be different from the update frequency of the dataset 34. Further, a format conversion protocol, as is known in the art, could be used to reformat the data contained in the dataset 34 and port this data as updated to the dataset 38.

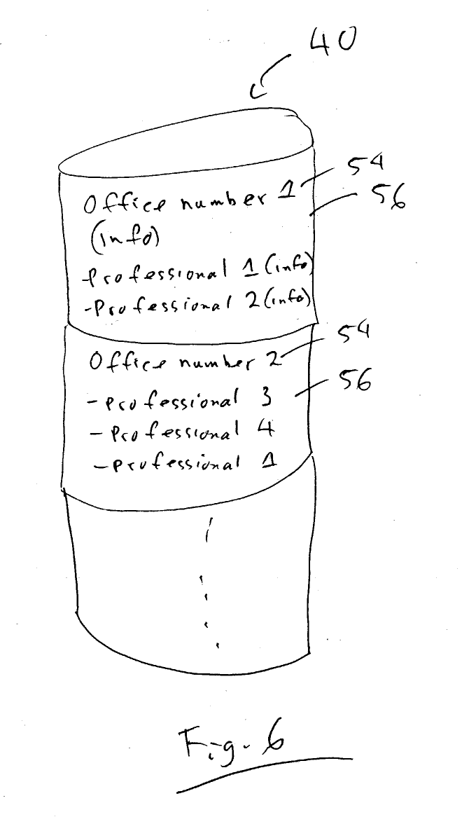

Referring to FIG. 6, the dataset 40 contains similar information as the full provider dataset 36, however the individual providers 56 are assigned with their provider office number 54 attached. It should be noted that the information contained in the dataset 40 is only that required to complete the claim 18. Extraneous provider 56 information, such as but not limited to history and validation information, may not required in the dataset 40. Accordingly, each provider professional in the dataset 40 may have more than 1 entry with different office numbers 54 attached. One advantage to the different provider datasets 36, 40 is that in the dataset 36 there could be multiple providers 56 with multiple office numbers 54 with individual associated patient and professional lists. Therefore, the access and retrieval of the provider claim information from the database 28 by the call centre 12 staff is facilitated, when the call centre 12 instead of the dataset 36 accesses the dataset 40. The dataset 40 is also updated on a preset interval, which may be different from the update frequency of the dataset 36. Further, a format conversion protocol, as is known in the art, could be used to reformat the data contained in the dataset 36 and port this data as updated to the dataset 40.

Accordingly, in view of the above, the datasets 38, 40 are sorted by provider office number 54 to facilitate claim 18 information retrieval and input into the claim 18 by the call centre 12 staff. This sorting of the full patient and provider information 34, 36 by office number 54 helps to reduce information overload as displayed on the interface 39, thereby helping the call centre 12 staff to straightforwardly access the required claim 18 information, rather than searching through complicated data structures and/or relying upon the provider 16 and/or patient 14 to manually provide the required claim 18 data. The full datasets 34, 36 are not accessed by the call centre 12 staff, unless the required patient 14 and provider 16 information are not present in the datasets 38, 40. In this case, the call centre 12 can take new patient 14 and/or provider 16 information and update the datasets 34, 36, 38, 40 before proceeding with completing the claim 18 submission. Further, it is noted that rather than having separate datasets 34, 36, 38, 40, the display contents of the full datasets 34, 36, on the interface 39, could be filtered by the office number 54, by using such as but not limited to pointers of object orientated languages, and appropriate provider 56 and/or patient 52 information requested. The patient and provider data includes the office numbers 54, which are used by the interface 39 as input to predefined unique identifier data fields in the electronic claim forms.

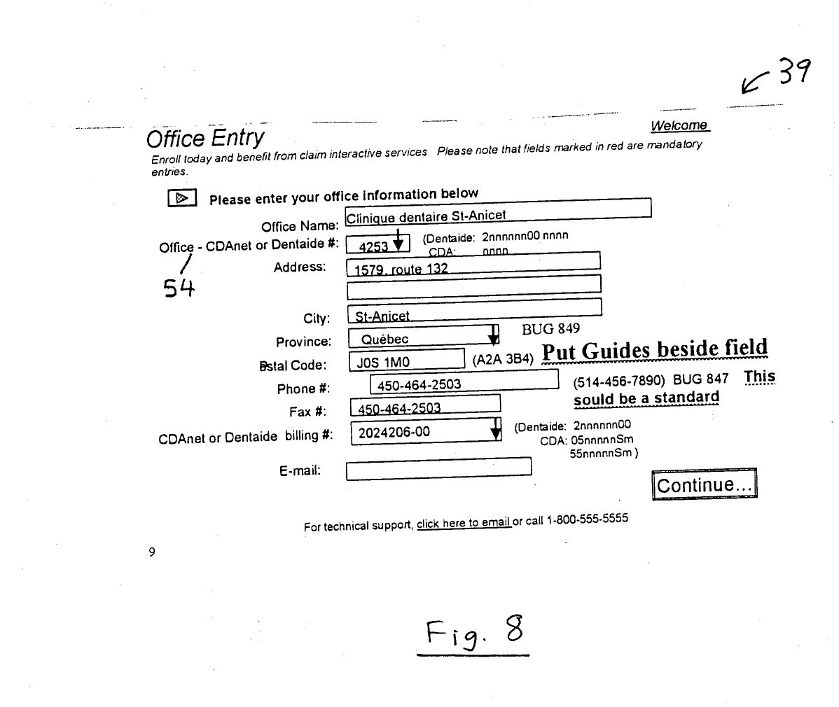

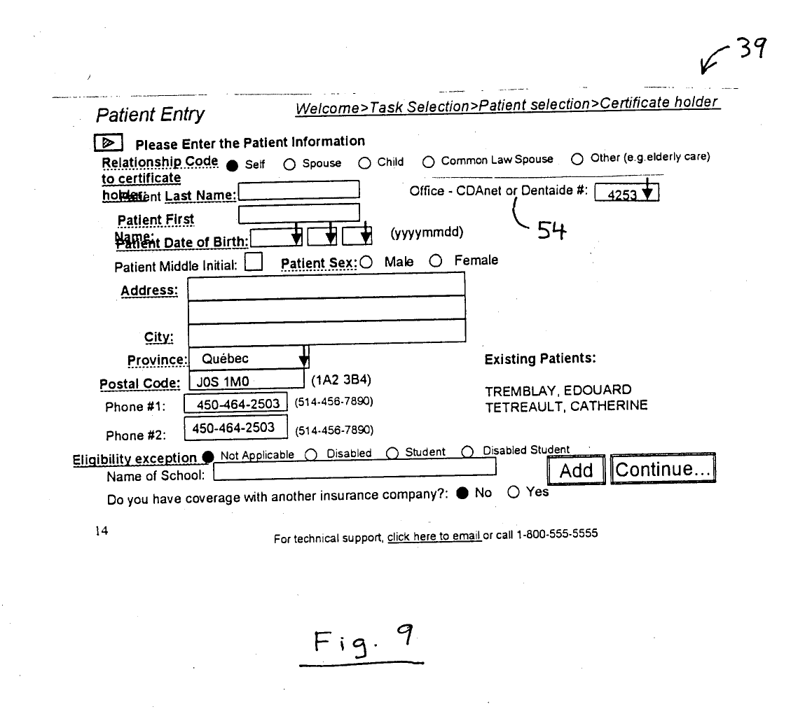

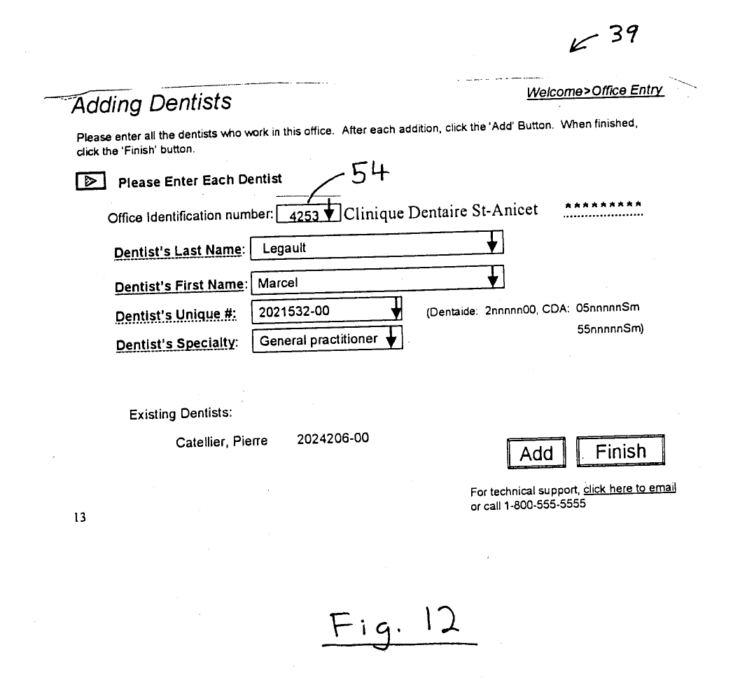

Referring to FIGS. 1, 5, 6, and 7, data retrieval 98 of the call centre 12 starts by first receiving a claim request 100 from the provider 16 using their office identifier 54, subsequently used by the data retrieval protocol. The call centre 12 enters 102 the identifier 54 into the interface 39 (see FIG. 8) and takes the patient name/ID. If the patient is listed 104 with the office identifier in the dataset 38, the call centre 12 retrieves 106 the relevant patient information (see FIG. 9) from the dataset 38. If the patient is not listed 104 with the office identifier in the dataset 38, the call centre 12 searches 108 all patients with the respective patient ID in the full dataset 34, as displayed on the interface 39. The appropriate patient is selected 110 from the full list and the patient is then added 112 to the dataset 38 attached to the appropriate office identifier 54. The call centre 12 then retrieves 106 the relevant patient information from the dataset 38. In the next step, the call centre 12 takes the individual provider name/ID (such as the dentist). If the individual provider is listed 114 with the office identifier in the dataset 40, the call centre 12 retrieves 116 the relevant individual provider information from the dataset 40. If the individual provider is not listed 114 with the office identifier 54 in the dataset 40, the call centre 12 searches 118 all individual providers with the respective individual provider ID in the full dataset 36, as displayed on the interface 39. The appropriate individual provider is selected 120 from the full list and the individual provider is then added 122 (see FIG. 12) to the dataset 40, attached to the appropriate office identifier 54. The call centre 12 then retrieves 116 the relevant individual provider information from the dataset 40.

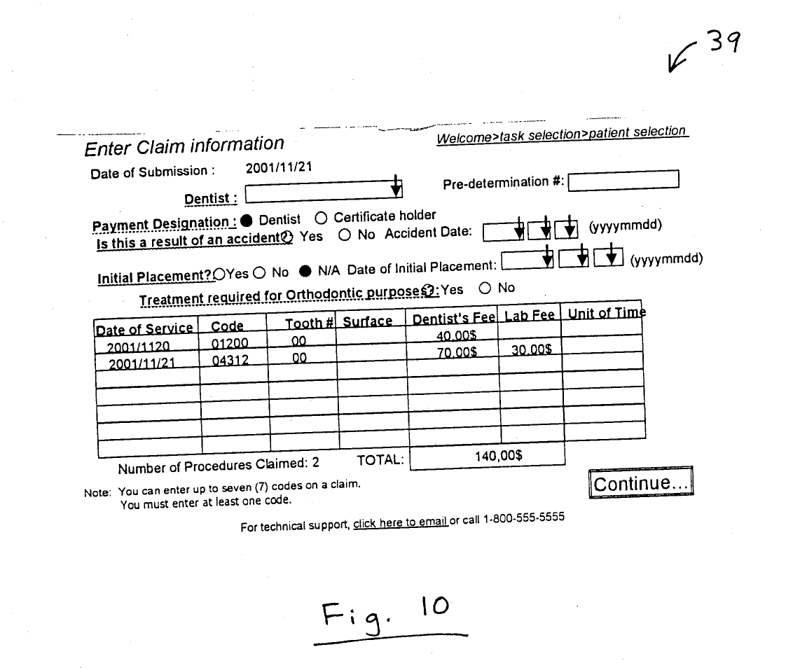

Once the above patient and provider information is complete, the call centre 12 then inputs 124 the specific claim transaction details (see FIG. 10) and submits 126 the claim 18 to the adjudication centre 26. The adjudication centre 26 then communicates 128 the results to the call centre 12, which in turn informs the provider 16. The involved call centre 12 staff is then free to take the next call 130.

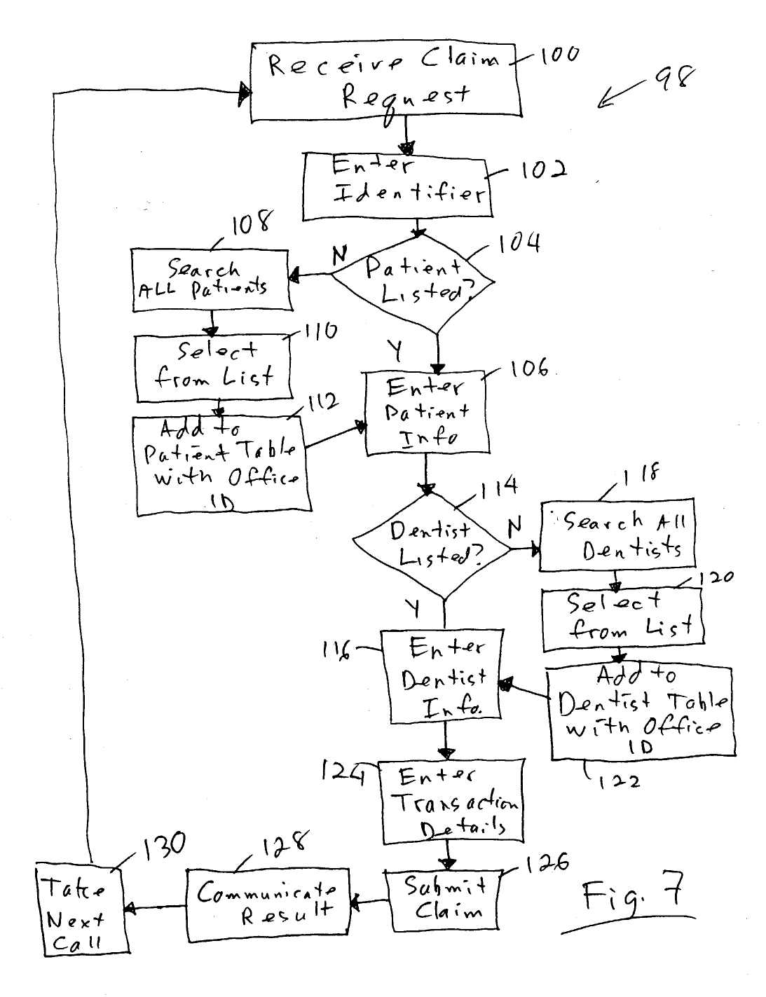

It should be noted that the claim submission process 98 is coordinated through use of the unique provider office numbers 54 with the data retrieval protocol. Therefore, when new patients and providers are registered, each is assigned to a specific office number 54. This office number 54 is used in the electronic claim forms to reduce the amount of information displayed on the interface 39, so as to help the call centre 12 staff streamline the claim 18 data capture process. Further, the import of the patient/provider data 50 supplied by the insurer 48 to the datasets 34, 36 can use a formatting routine to update the datasets 38, 40 used predominantly by the call centre 12 for display on the interface 39. Alternatively, a filtering routine could be used, dependent upon the office identification number 54, to access the full datasets 34, 36 when prompted by the call centre (initially at steps 104, 06, 114, 116 (see FIG. 7)), thereby limiting the amount of display data supplied to the interface 39. This filtering effectively could display the relevant patient/provider information by office number. One example of the filtering routine could use such as but not limited to pointers associated with object-oriented languages.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A system to provide requested insurance data for populating data fields of an electronic claim form, the system comprising:
a) a database including insurance related patient data and provider data;
b) an interface for accessing the database, the interface capable of displaying the electronic claim form on a display;
c) a unique identifier data field associated with the claim form, the unique identifier field for directing retrieval of the patient data and the provider data from the database, a set of unique identifiers employable by the unique identifier data field for associating an office location of each specified one of the providers with a respective one of the patients; and
d) a data retrieval protocol for displaying the insurance data according to a selected one of the unique identifiers entered in the identifier data field;
wherein the same unique identifier is associated with both the provider and the patient of the provider.

2. The system according to claim 1, wherein the database further comprises a patient database and a patient sub-database.

3. The system according to claim 1, wherein the database further comprises a provider database and a provider sub-database.

4. The system according to claim 3, wherein the provider data of the provider database includes multiple professional entries, each of the professional entries capable of being coupled to more than one of the unique identifiers.

5. The system according to claim 4, wherein the provider data of the provider sub-database includes multiple professional entries, each of the professional entries coupled to one of the unique identifiers.

6. The system according to claim 3, wherein the provider data of the provider database includes multiple provider entries, each of the provider entries capable of being coupled to more than one of the unique identifiers.

7. The system according to claim 2, wherein the patient data of the patient database includes multiple patient entries, each of the patient entries capable of being coupled to more than one of the unique identifiers.

8. The system according to claim 7, wherein the patient data of the patient sub-database includes multiple patient entries, each of the patient entries coupled to one of the unique identifiers.

9. The system according to claim 8, wherein the database further comprises a provider database and a provider sub-database.

10. The system according to claim 9, wherein the provider data of the provider database includes multiple professional entries, each of the professional entries capable of being coupled to more than one of the unique identifiers.

11. The system according to claim 10, wherein the provider data of the provider sub-database includes multiple professional entries, each of the professional entries being coupled to a common one of the unique identifiers.

12. The system according to claim 11, wherein the retrieval protocol retrieves provider data and associated patient data from the respective provider sub-database and the patient sub-database using the one common unique identifier.

13. The system according to claim 1 further comprising a filtering protocol used by the retrieval protocol.

14. The system according to claim 13, wherein the filtering protocol uses a common one of the unique identifiers to access both the patient data and provider data of the database.

15. The system according to claim 14, wherein the filtering protocol limits the amount of patient and provider data displayed by the interface, the filtering displaying relevant patient and provider information according to the common one of the unique identifiers.

16. The system according to claim 15, wherein the filtering protocol employs an object oriented pointer associated with the common one of the unique identifiers.

17. A computer program product to provide requested insurance data for populating data fields of an electronic claim form, the computer program product comprising:
a) a computer readable medium;
b) a database module stored on the computer readable medium for including insurance related patient data and provider data;
b) an interface module coupled to the database module, the interface module capable of displaying the electronic claim form on a display;
c) a unique identifier module associated with the claim form, the unique identifier module for directing retrieval of the patient data and the provider data from the database module, a set of unique identifiers employable by the identifier module for associating an office location of each specified one of the providers with a respective one of the patients; and
d) a data retrieval module for displaying the insurance data according to a selected one of the unique identifiers used by the identifier module;
wherein the same unique identifier is associated with both the provider and the patient of the provider.

18. The computer program product according to claim 17, wherein the database module further comprises a patient database and a patient sub-database.

19. The computer program product according to claim 17, wherein the database module further comprises a provider database and a provider sub-database.

20. The computer program product according to claim 19, wherein the provider data of the provider database includes multiple professional entries, each of the professional entries capable of having more than one of the unique identifiers.

21. The computer program product according to claim 20, wherein the provider data of the provider sub-database includes multiple professional entries, each of the professional entries having one of the unique identifiers.

22. The computer program product according to claim 19, wherein the provider data of the provider database includes multiple provider entries, each of the provider entries capable of having more than one of the unique identifiers.

23. The computer program product according to claim 18, wherein the patient data of the patient database includes multiple patient entries, each of the patient entries capable of having more than one of the unique identifiers.

24. The computer program product according to claim 23, wherein the patient data of the patient sub-database includes multiple patient entries, each of the patient entries having one of the unique identifiers.

25. The computer program product according to claim 24, wherein the database module further comprises a provider database and a provider sub-database.

26. The computer program product according to claim 25, wherein the provider data of the provider database includes multiple professional entries, each of the professional entries capable of having more than one of the unique identifiers.

27. The computer program product according to claim 26, wherein the provider data of the provider sub-database includes multiple professional entries, each of the professional entries having one of the unique identifiers.

28. The computer program product according to claim 27, wherein the retrieval module retrieves provider data and associated patient data from the provider sub-database and the patient sub-database using the one unique identifier.

29. The computer program product according to claim 17, wherein the retrieval module provides the insurance data to the interface module for automatically pre-populating the respective data fields.

30. A method to provide requested insurance data for populating data fields of an electronic claim form, the method comprising the steps of:
a) supplying a database including insurance related patient data and provider data;
b) associating a unique identifier data field with the claim form, the unique identifier field for directing retrieval of the patient data and the provider data from the database, the unique identifier data field using a set of unique identifiers for relating an office location of each specified one of the providers with a respective one of the patients;
c) entering a selected one of the unique identifiers in the identifier data field;
d) retrieving the insurance data from the database according to the selected one of the unique identifiers; and
e) displaying the retrieved data in the electronic claim form;
wherein the same unique identifier is associated with both the provider and the patient of the provider.
